(19) United States
(12) Patent Application Publication
(10) Pub. No.: US 2014/0066204 A1
(43) Pub. Date: Mar. 6, 2014

(54) GAME DEVICE, CONTROL METHOD, AND PROGRAM

(71) Applicants: WIZ CO., LTD., Tokyo (JP); BANDAI CO., LTD., Tokyo (JP)

(72) Inventors: Kaori KITSUGI, Tokyo (JP); Maki TAKEUCHI, Tokyo (JP); Sachiko YAMAGISHI, Tokyo (JP)

(73) Assignees: WIZ CO., LTD., Tokyo (JP); BANDAI CO., LTD., Tokyo (JP)

(21) Appl. No.: 14/015,226

(22) Filed: Aug. 30, 2013

(30) Foreign Application Priority Data
Aug. 31, 2012 (JP) 2012-192233

(51) Int. Cl. A63F 13/00

(52) U.S. Cl. CPC A63F 13/00
USPC 463/31; 463/36

(57) ABSTRACT

A game device executes a game in which a manipulated character is brought up. When a first manipulation input is accepted, the game device controls events that are generated for a manipulated character in the game and require manipulation inputs by the user of the game device so that a non-generation state, in which their generation is not allowed, is entered. Accordingly, restrictions involved in the behavior of the user are reduced.

### CROSS REFERENCES TO RELATED APPLICATIONS

The present invention contains subject matter related to Japanese Patent Application No. 2012-192233 filed in the Japan Patent Office on Aug. 31, 2012, the entire contents of which are incorporated herein by reference.

### BACKGROUND OF THE INVENTION

1. Field of the Invention

The present invention relates to a game device, a control method and a program, and more particularly to a game in which a character is brought up.

2. Description of the Related Art

Some games that bring up a character can be executed in a game device that a user can carry so that growth processes of the character can be monitored. A portable game device as described in Japanese Unexamined Patent Application Publication No. 2009-028102 has a function that generates a sound to notify the user that an event, such as a demand from a character, that requires a manipulation by the user has occurred during a growth process of the character. This type of function is aimed at giving the user a spurious feeling as if the user were bringing up the character in the real world. The user can respond to a demand from the character by, for example, manipulating the device within a prescribed time after the notification, in which case the user can increase the value of a parameter of the character (can bring up the character).

### SUMMARY OF THE INVENTION

When an event needs a manipulation by the user as in Japanese Unexamined Patent Application Publication No. 2009-028102, if the user could not make a manipulation within a prescribed time after the notification of the event, the value of a parameter of the character may be disadvantageously decreased. With game devices as described in Japanese Unexamined Patent Application Publication No. 2009-028102, decreasing parameter values is a widespread practice to increase game characteristics. To avoid a decrease in the parameter value of the character, the user has been needed to be always aware of notifications, which occur at random, from the game device.

However, the above situation has not been preferable because the behavior of the user is restricted; for example, even if the user is on a trip, the user has to be aware of notifications. In a situation in which the game device cannot be carried, it is inevitable that the parameter value of the character is decreased. As a result, the interest of the user may be lost.

The present invention addresses the above problem with the object of providing a game device, a control method, and a program that reduce restrictions involved in the behavior of a user who uses the game device.

To achieve the above object, the game device according to the present invention has a structure described below.

The game device that executes a game in which a manipulated character is brought up has an event generating means that generates an event concerning the manipulated character, an input means that accepts a manipulation input by a user, and a control means that controls generation of events by the event generating means, the events require a manipulation input by the user; when a first manipulation input is accepted by the input means, the control means controls the event generating means so as to be placed in a non-generation state in which the event generating means is not allowed to generate an event that requires a manipulation input.

The present invention having this structure can reduce restrictions involved in the behavior of a user who uses the game device.

### BRIEF DESCRIPTION OF THE DRAWINGS

FIG. 1 illustrates an external appearance of a game device and an accessory in an embodiment of the present invention.

FIG. 2 is a block diagram illustrating the functional structure of the game device and accessory in the embodiment of the present invention.

FIG. 3 is a flowchart illustrating temporary character entrusting processing executed by the game device in the embodiment of the present invention.

FIG. 4 is a flowchart illustrating character single-point manipulation processing executed by the game device in the embodiment of the present invention.

FIG. 5 is a flowchart illustrating communication game processing executed by the game device in the embodiment of the present invention.

FIG. 6 is a flowchart illustrating link processing executed by the game device in the embodiment of the present invention.

FIG. 7 is a flowchart illustrating delinking processing executed by the game device in the embodiment of the present invention.

FIGS. 8A to 8D illustrate the structures of data used by the game device and accessory in the embodiment of the present invention.

### DESCRIPTION OF THE PREFERRED EMBODIMENTS

### Embodiment

An illustrative embodiment of the present invention will be described in detail with reference to the drawings. In an example in an embodiment described below, the present invention will be applied to a game device that executes a game in which a manipulated character is brought up. However, this is not a limitation; the present invention can also be applied to any device that can execute a game in which a manipulated character is brought up.

External appearance of a game device 100

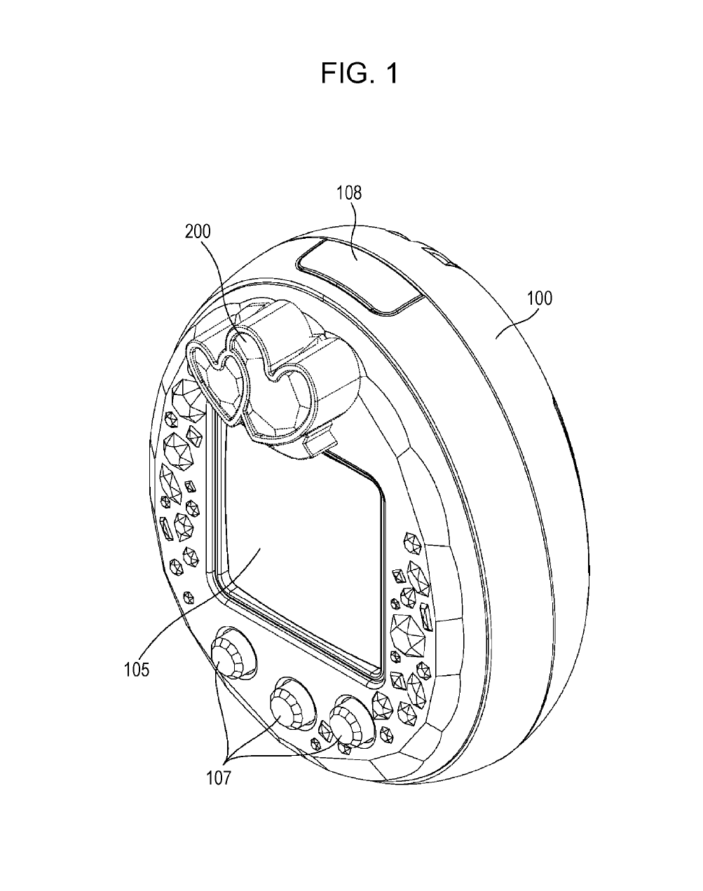

FIG. 1 illustrates an external appearance of the game device 100 in an embodiment of the present invention. As illustrated in the drawing, the game device 100 includes a display unit 105 on which a screen of game content is displayed, a manipulation input unit 107 that accepts manipulation inputs from the user, and a communication unit 108 that performs infrared data communication with another game device.

An accessory 200 can also be attached to the game device 100 in this embodiment. The accessory 200 has a recording unit that stores additional elements of the game content and other data. When attached to the game device 100, the accessory 200 provides various functions.

Functional Structures of the Game Device 100 and Accessory 200

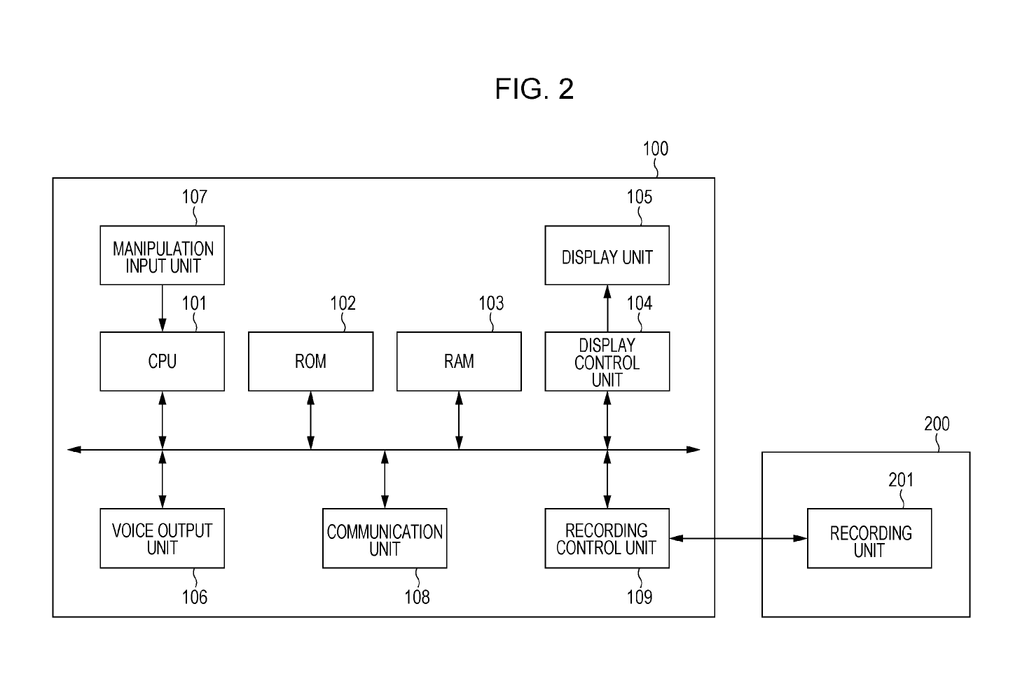

Next, the functional structures of the game device 100 and accessory 200 in this embodiment of the present invention will be described in detail with reference to the block diagram in FIG. 2.

The central processing unit (CPU) 101 controls the operations of blocks included in the game device 100. Specifically, to control the operation of a block, the CPU 101 reads out an operation program, for the block, that corresponds to processing described later, the operation program being stored in, for example, a read-only memory (ROM) 102, stores the read-out program in a random-access memory (RAM) 103, and executes the program.

The ROM 102 is, for example, a non-rewritable non-volatile memory. It stores not only the operation programs for the blocks included in the game device 100 but also, for example, parameters that are required for the blocks to operate. The RAM 103 is, for example, a volatile memory. It is used not only as an area where the operation programs for the blocks are stored but also as a storage area where intermediate data output during the operations of the blocks, data obtained through communication, and other data are stored.

The display control unit 104 controls displays given on the display unit 105. Specifically, the display control unit 104 uses a character and graphic data such as a background, which are stored in, for example, the ROM 102 to create screen data and displays it on the display unit 105. The display unit 105 is, for example, a liquid crystal display (LCD) or another display unit; screen data created by the display control unit 104 is displayed on a display area on the display unit 105.

The sound output unit 106, which is, for example, a speaker, accepts an input of a sound signal involved in sound data that has been read out from the ROM 102 and reproduced, and outputs sound under control of the CPU 101.

The manipulation input unit 107 is a user interface of the game device 100; the user interface includes manipulation buttons or the like. Upon detection of a manipulation input by the user, the manipulation input unit 107 transmits a control signal corresponding to the manipulation to the CPU 101.

The communication unit 108 is a communication interface of the game device 100; the communication interface is used for data communication. Although, in this embodiment, the communication unit 108 will be described, assuming that it performs data communication with another game device 100 in an infrared communication method, the communication method used by the communication unit 108 is not limited to this.

The accessory 200 is removably attached to the game device 100. With the accessory 200 attached to the game device 100, the recording control unit 109 controls the writing of data to a recording unit 201 included in the accessory 200 and the reading of data from the recording unit 201. The recording control unit 109 can determine whether the accessory 200 is attached, according to whether a connector (not illustrated) is electrically connected. The recording unit 201 may be, for example, a volatile memory or another rewritable storage device.

Outline of Game Content

Game content will be first outlined that is executed in the game device 100 in this embodiment to bring up a manipulated character.

The user can cause the manipulated character to perform a desired operation by using the manipulation input unit 107 to manipulate the character. Basically, in the game content in this embodiment, the manipulated character is displayed on the display unit 105 and the user can view its operation. The character shifts through a plurality of growth stages in the game and grows according to elapsed times or manipulation inputs performed by the user.

A plurality of parameters such as cleverness and physical strength are provided for the manipulated character. The value of the relevant parameter is increased or decreased according to the manipulation input by the user. In addition to the manipulation input arbitrarily performed by the user, the value of the parameter is increased or decreased according to the manipulation input in a forcible event that occurs at random. The forcible event is an event, involved in a manipulated character, that requires a manipulation input by the user. Generation of a forcible event is indicated by at least any one of a display on the display unit 105 and a sound output to the sound output unit 106. Although a frequency at which forcible events occur varies depending on the growth stage of the character, at least one forcible event occurs in a day.

In this embodiment, the manipulated character is subjected to four growth stages described below.

1. Infant period: At least one type of form is provided for each sex. Forcible event frequently occur. The character shifts to the rebellious period in about one hour.

2. Rebellious period: Two types of forms are provided for each sex. A form selected at random is used. Forcible event frequently occur. The character shifts to the adolescent period in about 24 hours. The character can be temporarily entrusted to a nursery school.

3. Adolescent period: Two types of forms are provided for each sex. Either form is selected according to the values of the parameters used before the adolescent period. The character shifts to the friend period in about 24 hours. The character can be temporarily entrusted to a nursery school.

4. Friend period: Many types of forms are provided for each sex. One form is selected according to the values of the parameters used before the friend period. Since there is no next growth stage, a time limitation is not imposed. The growth of the character remains in this stage. The character can be temporarily entrusted to a school.

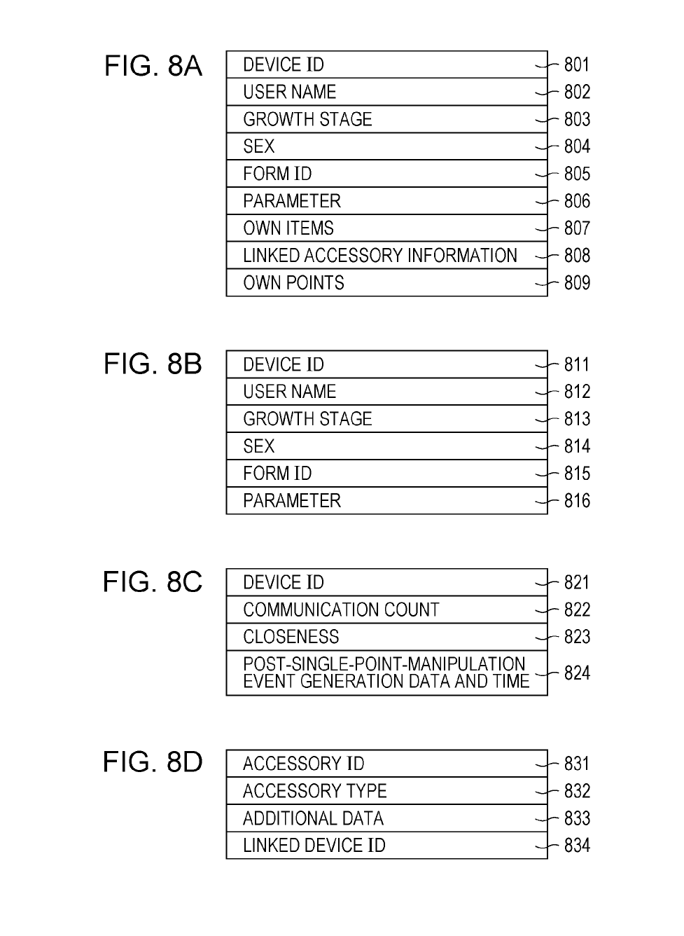

This type of information used in the game in relation to the manipulated character (information about the manipulated character) may be managed as part of game information having a data structure as illustrated in, for example, FIG. 8A. The game information includes a device ID 801, which indentifies the game device 100, a user name 802, which is set by the user on the game device 100 to indicate the user, and information about the manipulated character. The game information is stored, in for example, the RAM 103. The information about manipulated character includes, for example, a current growth stage 803 of the manipulated character, a sex 804, a selected form ID 805, and a parameter 806. The game information also includes own items 807 that the user can use for the manipulated character in the game, linked accessory information 808 fetched from the accessory 200 described later, and own points 809 used to buy items in the game and for other purposes. The items include items that the manipulated character can use as tools and also include additional elements, defined for the game, that are involved in the behavior of the manipulated character, such as a movement destination of the character.

Temporary Character Entrusting Processing

In the game content in this embodiment, at least one forcible event involved in an increase or a decrease in the value of a parameter occurs in a day. Since generation of a forcible event may restrict the behavior of the user as described above, however, the game content in this embodiment enables the game device 100 to temporarily enter the non-generation state, in which forcible events are not generated for the character. Specifically, in the rebellious period, adolescent period, and friend period, the user can entrust the character to a nursery school or a school by performing a prescribed manipulation. Since the user can set a state that disables generation of forcible events by placing the manipulated character in the temporary character entrusting state, even in a situation in which, for example, the user cannot carry the game device 100, the user can prevent the value of a parameter from being decreased as a penalty, which would otherwise be caused when the user does not make an input in response to a forcible event.

In the description below, assuming that the age bracket of the main users of the game content in this embodiment is children in elementary schools, temporary character entrusting processing for nursery schools is forcibly cancelled at 15 o'clock and that for schools is forcible canceled at 17 o'clock, but this is not a limitation; in at least two growth stages in this embodiment, when the manipulated character in a stage (for example, a second stage later than a first stage) other than at least one stage, it suffices that a time at which temporary character entrusting processing is cancelled is later than in the at least one stage (for example, the first stage).

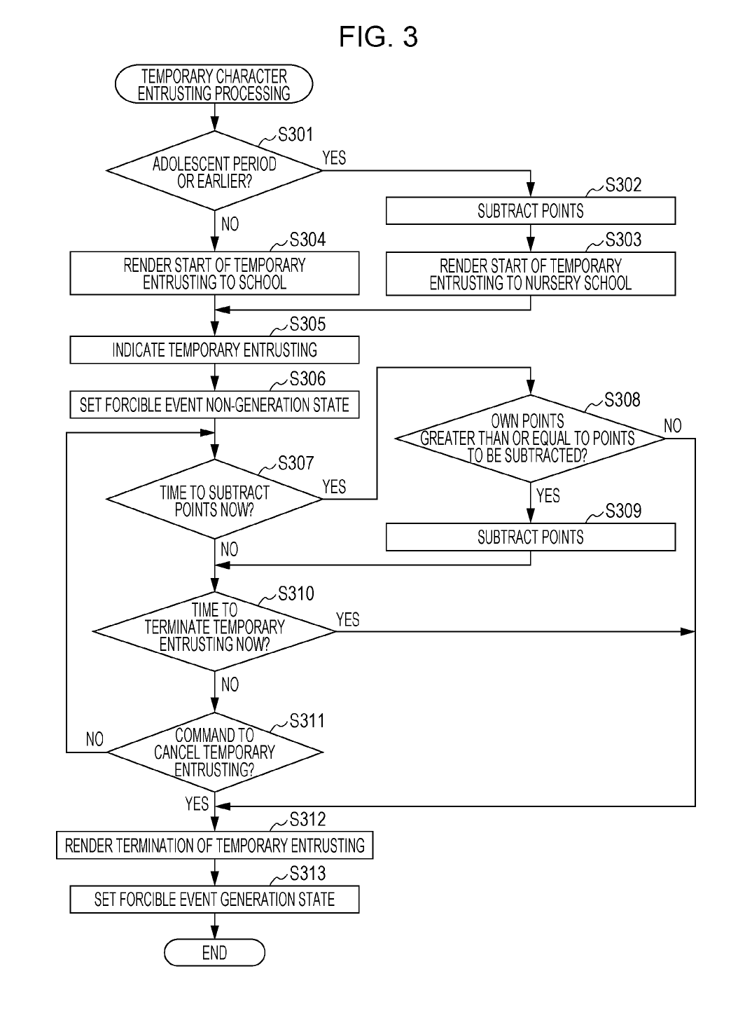

Temporary character entrusting processing executed in the game device 100 in this embodiment will be specifically described with reference to the flowchart in FIG. 3. In the description below, temporary character entrusting processing is assumed to be started by the CPU 101 when, for example, a control signal corresponding to a manipulation to entrust the manipulated character to a nursery school or a school is received.

In S301, the CPU 101 determines whether the growth stage of the manipulated character is the adolescent period or earlier. Specifically, the CPU 101 reads out information about the growth stage 803 of the manipulated character from the RAM 103 and determines whether the information is the rebellious period or adolescent period. If the CPU 101 determines that the growth stage of the manipulated character is the adolescent period or earlier, processing proceeds to S302. If the CPU 101 determines that the growth stage is the friend period, processing proceeds to S304.

If the growth stage of the manipulated character is the infant period, the game device 100 in this embodiment does not accept any manipulation input to execute the temporary character entrusting processing. That is, in S301, assuming that the growth stage of the manipulated character is any one of the rebellious period, adolescent period, and friend period, the CPU 101 determines whether the manipulated character should be entrusted to a nursery school or a school depending whether the growth stage is the adolescent period or earlier.

In S302, the CPU 101 decreases predetermined points from the value of the own points 809 of the manipulated character and sets the obtained value as the own points 809. In the game content executed in the game device 100 in this embodiment, if the growth stage of the manipulated character is the adolescent period or earlier, a function to temporarily entrust the character is can be used under the condition that the prescribed points are subtracted. This is aimed at user's prolonged use of the game. If, in the experience of the game content, the user experiences growth stages that are likely to take much time and efforts in the growth of the manipulated character as much as possible, the user can understand the manipulation of the game in greater depth and can enhance an attachment to the manipulated character. Accordingly, to dissuade the user from using the temporary entrusting function in the adolescent period or rebellious period, in the game content in this embodiment, points are subtracted as a condition to use the temporary entrusting function in the adolescent period or rebellious period, according to the length of a time during which the character is entrusted; for example, 50 points are subtracted per hour.

In S303, the CPU 101 reads out, from the ROM 102, rendering data indicating that temporary entrusting to a nursery school has started and causes the display control unit 104 to display a screen on the display unit 105 according to the rendering data. Although, in the description below, rendering in the game device 100 is assumed to be performed by displaying a screen on the display unit 105, it should be understood that sound reproduction by the sound output unit 106 may also be used as rendering.

If the growth stage of the manipulated character is the friend period, in S304 the CPU 101 reads out, from the ROM 102, rendering data indicating that temporary entrusting to a school has started and causes the display control unit 104 to display a screen on the display unit 105 according to the rendering data.

In S305, the CPU 101 reads out, from the ROM 102, graphical user interface (GUI) data indicating that temporary entrusting is in progress, and transfers the GUI data to the display control unit 104 to cause the display control unit 104 to display the GUI data on the display unit 105. Since the manipulated character is being temporary entrusted, however, graphic data of the manipulated character is not displayed on the display unit 105, but a message such as, for example, “Absent” indicating that the manipulated character is absent due to temporary entrusting is displayed on the background data.

In S306, the CPU 101 sets the non-generation state, in which forcible events requiring user's manipulation inputs are not allowed to be generated, as the state of the game device 100. Whether to allow generation of forcible events is managed with, for example, a logical forcible event generation flag in the RAM 103. The CPU 101 controls execution of forcible event generation processing depending on whether the flag is true (generation of forcible event is allowed) or false (generation of forcible event is not allowed).

In S307, the CPU 101 determines whether the current time is a time to subtract additional points. Specifically, the CPU 101 determines whether the current time has reached a time obtained by adding an integer multiple of a prescribed period to the start time of temporary entrusting. With the game content in this embodiment, while the manipulated character is being temporarily entrusted to a nursery school, points are subtracted at intervals of a prescribed period, as described above. If the CPU 101 determines that the current time is a time to subtract additional points, processing proceeds to S308. If not, the processing proceeds to S310. The integer multiple used in the determination in S307 is set to 1 at the start of entrusting and is incremented by one each time the next step, S308, is executed.

In S308, the CPU 101 determines whether the own points 809 to be stored in the RAM 103 is greater than or equal to the points to be subtracted. If the CPU 101 determines that the own points 809 is greater than or equal to the points to be subtracted, the processing proceeds to S309. If the CPU 101 determines that the own points 809 is smaller than the points to be subtracted, the processing proceeds to S312.

In S309, the CPU 101 subtracts a prescribed number of points from the own points 809. The determination in S307 is carried out only when the growth stage 803 of the manipulated character is the adolescent period or earlier, so processing in S307 to S309 is carried out only when the growth stage 803 of the manipulated character is the adolescent period or earlier.

In S310, the CPU 101 determines whether the current time has reached a time to terminate temporary entrusting. With the game content in this embodiment, different times to terminate temporary entrusting are set for a nursery school and a school to which to entrust the character. Accordingly, when the current time reaches a time to terminate temporary entrusting, the manipulated character shifts from the temporary entrusting state to a normal state in which forcible events are allowed to be generated. Different temporary entrusting termination times for the nursery school and the school are set so that a time set for the nursery school (for example, 15:00) is earlier than a time set for the school (for example, 17:00). An aim of this is to prevent more points than necessary are subtracted from the points available to the user due to a lengthy temporary entrusting period at a nursery school. If the CPU 101 determines that the current time has reached a time to terminate temporary entrusting, processing proceeds to S312. If not, processing proceeds to S311.

In S311, the CPU 101 determines whether the user has issued a command to cancel the temporary entrusting state of the manipulated character. Specifically, the CPU 101 determines whether a control signal corresponding to a manipulation input involved in canceling the temporary entrusting has been received from the manipulation input unit 107. If the CPU 101 determines that a command to cancel the temporary entrusting state of the manipulated character has been issued, processing proceeds to S312. If not, processing returns to S307.

A condition involved in canceling the temporary entrusting is satisfied, when the CPU 101 determines in S308 that the own points 809 are smaller than the points to be subtracted, or the CPU 101 determines in S310 that the current time has reached a time to terminate temporary entrusting and also determines in S311 that a command to cancel the temporary entrusting state of the manipulated character has been issued. If the above condition is satisfied, the CPU 101 renders termination of temporary entrusting in S312. Specifically, the CPU 101 reads, from the ROM 102, rendering data indicating that temporary entrusting has been terminated, after which the CPU 101 causes the display control unit 104 to display a screen on the display unit 105 according to the rendering data. The display on the display unit 105 is graphic data of the manipulated character.

In S313, the CPU 101 sets a generation state, in which forcible events requiring user's manipulation inputs are allowed to be generated, as the state of the game device 100.

Thus, with the game content executed in the game device 100 in this embodiment, the user can set a state that disables generation of forcible events requiring manipulation inputs by placing the manipulated character in the temporary character entrusting state.

Single-Point Manipulation Processing

When the game device 100, in this embodiment, possessed by a user communicates with another game device 100 possessed by another user, manipulated characters on the two game devices 100 can be manipulated only on either game device 100. In this case, a plurality of manipulated characters are displayed on the display unit 105 of one game device 100, and not displayed on the other game device 100, performing rendering as if a manipulated character had moved to a different game device.

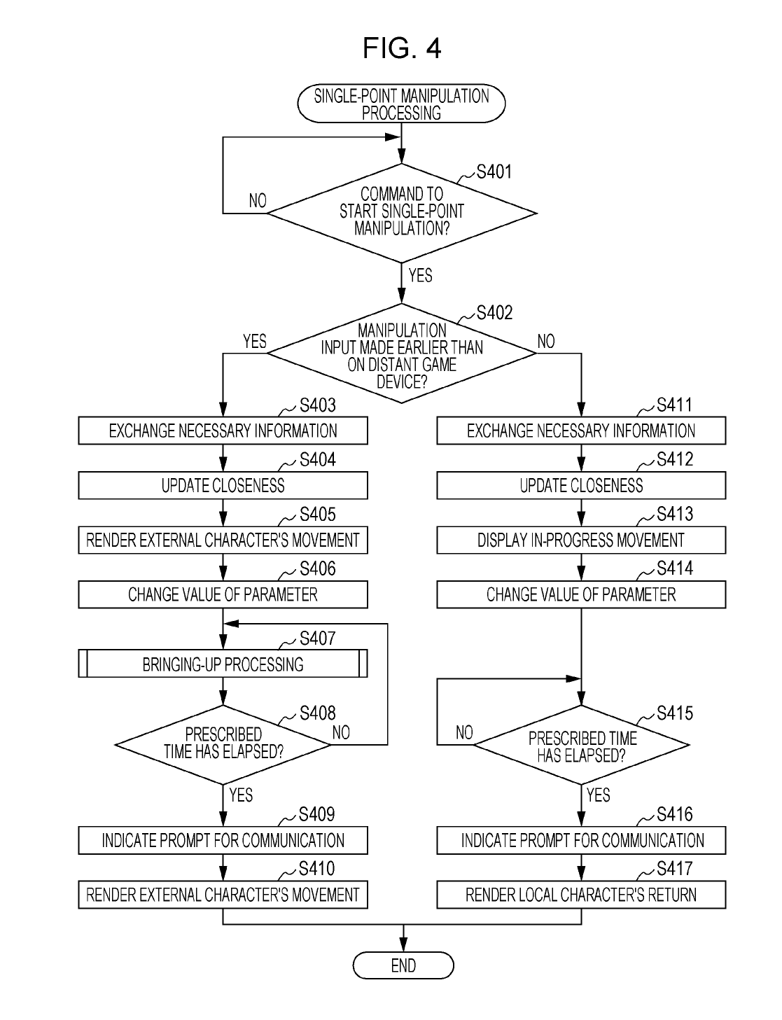

Single-point manipulation processing in which a plurality of manipulated characters can be manipulated on a single game device 100 will be specifically described with reference to the flowchart in FIG. 4. Processing in the flowchart is executed by each CPU 101 in a plurality of game devices 100 that are mutually communicating. In the description below, this single-point manipulation processing is assumed to be executed when, for example, a plurality of game devices 100 set in a communication mode to perform single-point manipulation processing are mutually connected for communication. To simplify the description below, processing is assumed to be carried out between two game devices 100. However, this is not a limitation; characters to be subjected to single-point manipulation may be brought up on three or more game devices 100. The single-point manipulation processing can be executed among a plurality of game devices 100.

In S401, the CPU 101 determines whether a user has made a manipulation input to start single-point manipulation of characters. If the CPU 101 determines that a user has made a manipulation input to start single-point manipulation of characters, processing proceeds to S402. If not, processing in S401 is repeated.

In S402, the CPU 101 determines whether a manipulation input to start single-point manipulation of characters has been made on the local game device 100 earlier than on the distant game device 100 with which communication is being performed. Of the two game devices 100 mutually connected for communication, a game device 100 on which a manipulation input to start single-point manipulation of characters has been first made after the connection for communication is determined as the game device 100 eligible for single-point manipulation of characters. That is, in S402, the CPU 101 determines whether to perform single-point manipulation for the characters on the local game device 100. If the CPU 101 determines that a first manipulation input to start single-point manipulation of characters has been made on the local game device 100, processing proceeds to S403. If the CPU 101 determines that the first manipulation input to start single-point manipulation of characters has been made on the distant game device 100, processing proceeds to S411.

In S403, the CPU 101 exchanges necessary information with the distant game device 100. The necessary information includes a device ID 811, a user name 812, a growth stage 813, a sex 814, a form ID 815, and a parameter 816, as illustrated in, for example FIG. 8B. Specifically, the CPU 101 creates necessary information from game information stored in the RAM 103 and transmits the created information to the distant game device 100 through the communication unit 108. The CPU 101 also receives necessary information from the distant game device 100 through the communication unit 108 and stores the received information in the RAM 103, after which processing proceeds to S404. After necessary information has been exchanged in S403, processing can be made to progress on each game device 100, so a notification indicating that the connection for communication may be disconnected is displayed on the display unit 105.

In S404, the CPU 101 updates information about closeness between a manipulated character brought up on the distant game device 100 (external character or guest character) and a manipulated character brought up on the local game device 100 (local character or host character), according to the necessary information received in S402. In this embodiment, the information about closeness is determined according to the number of communications performed. Information about the communication count and closeness may have a data structure as illustrated in, for example, FIG. 8C. Information about a communication count 822 and closeness 823 are managed in relation to the device ID 821 of the distant game device 100. With the game content in this embodiment, the communication count 822 and closeness 823 has a relationship as indicated in the table below.

| Communication count | Rank | Closeness |
|---|---|---|
| 1 to 5 | Acquaintance | Low |
| 6 to 11 | Friend | ↑ |
| 12 to 18 | Good friend | ↓ |
| 19 | Best friend | High |

The CPU 101 updates the communication count 822 corresponding to the device ID of the distant game device 100 according to the necessary information. If the communication count 822 satisfies a condition under which the closeness is increased, the CPU 101 also updates the closeness 823.

In S405, the CPU 101 displays the rendering of external character's movement from the distant game device 100. Specifically, the CPU 101 reads out, from the ROM 102, movement rendering data that uses graphic data of the external character with reference to the form ID 815 in the necessary information received in S402, and causes the display control unit 104 to display a screen on the display unit 105 according to the rendering data.

In S406, the CPU 101 determines an item that increases or decreases the value of a parameter of the local character, the item being received as a “souvenir” from the external character that has moved from the distant game device 100. The parameter increasing or decreasing item is determined according to the closeness to the target external character; the higher the closeness is, the higher the possibility of a plus factor item being determined is, the plus factor item increasing the value of the parameter; the lower the closeness is, the higher the possibility of a minus factor item being determined is, the minus factor item decreasing the value of the parameter. After having determined an item, the CPU 101 reads out GUI data corresponding to the determined item from the ROM 102, displays the GUI data on the display unit 105, and then changes the value of the parameter 806 of the local character according to the item.

In S407, the CPU 101 executes processing to bring up both the local character and external character. The bringing-up processing may be, for example, processing for an event generated for the bringing-up of the local character during non-communication. A screen is displayed according to the event and the manipulation input performed in response to the event. The bringing-up processing is not limited to this; it may be, for example, processing for an event that has a showdown or determines a feasibility as in communication game processing described later or processing that involves changing the value of the parameter according to the event. The value of the parameter may be increased when, for example, the result of the event indicates a win or success and may be decreased when, for example, the result of the event indicates a loss or failure.

In the single-point manipulation processing in this embodiment, the growth stages of the local character and external character do not change. This is because the user of the distant game device 100 may be unable to confirm the growth of its manipulated character, that is, the external character. In other words, when single-point manipulation is canceled, the external character having a different form due to its growth would return from the movement destination. This may confuse the user. As for the local character, movement between game devices is not rendered, so the local character may grow.

In S408, the CPU 101 determines whether an execution time spent in the single-point manipulation processing has reached a prescribed time. In the game content in this embodiment, an execution time in the single-point manipulation processing is predetermined, so in S408, the CPU 101 determines whether a time to terminate the single-point manipulation processing has been reached. If the CPU 101 determines that the execution time spent in the single-point manipulation processing has reached the prescribed time, processing proceeds to S409. If not, processing returns to S407. Measurement of the execution time in the single-point manipulation processing may be started when, for example, the necessary information is exchanged.

In S409, the CPU 101 displays, on the display unit 105, a prompt for communication with the distant game device 100. After communication has been established, processing proceeds to S410.

In S410, the CPU 101 displays the rendering of external character's movement toward the distant game device 100, and then completes this single-point manipulation processing.

If, in S402, the CPU 101 determines that a manipulation input to start single-point manipulation of characters has been made on the distant game device 100 with which communication is being performed earlier than on the local game device 100, the CPU 101 exchanges necessary information with the distant game device 100 in S411.

In S412, the CPU 101 updates the communication count 822 and closeness 823 between the external character (host character) and the local character (guest character) according to the necessary information received in S411.

In S413, the CPU 101 reads out, from the ROM 102, GUI data indicating that the local character is moving toward the distant game device 100, and transfers the GUI data to the display control unit 104 to cause the display control unit 104 to display the GUI data on the display unit 105. The GUI data indicating that the local character is moving may be, for example, “Absent” or another display and may be superimposed on the background data, as in temporary entrusting processing.

In S414, the CPU 101 increases the value of the parameter 806 in the game information stored in the RAM 103 by a prescribed value. With the game content in this embodiment, when the local character is subjected to single-point manipulation on another game device 100, the manipulation of the local character is disabled on the local game device 100, but upon completion of the single-point manipulation, the parameter value is increased by a certain value. Although the increasing of the parameter value may be performed during communication after the single-point manipulation, communication may fail or may not be performed, so the game information is updated after a prescribed value elapses from the first communication.

In S415, the CPU 101 determines whether an execution time spent in the single-point manipulation processing on the distant game device 100 has reached a prescribed time. If the CPU 101 determines that the execution time spent in the single-point manipulation processing on the distant game device 100 has reached the prescribed time, processing proceeds to S416. If not, the processing in S415 is repeated.

In S416, the CPU 101 displays, on the display unit 105, a prompt for communication with the distant game device 100. After communication has been established, processing proceeds to S417.

In S417, the CPU 101 displays the rendering of local character's return from the distant game device 100, and then completes this single-point manipulation processing.

Single-Point Manipulation Post-Processing

With the game content executed by the game device 100 in this embodiment, upon completion of single-point manipulation on the distant game device 100, a communication event occurs in which the external character, which will be brought up on the game device 100 that has been a distant party, appears on the local game device 100 without communication. Since a display mode on the display unit 105 is the same as in the single-point manipulation processing, the event is recognized by the user as a pseudo communication event. Since a time to generate the event is predetermined during the execution of the single-point manipulation processing, it is possible to perform rendering so that the external character, which is the manipulated character on the game device 100 that has been a distant party, disappears from the display unit 105 of the distant game device 100 and the external character appears on the display unit 105 of the local game device 100.

Single-point manipulation post-processing, in which an event occurs in this way, is performed after completion of a single-point manipulation on both a game device 100 (manipulating game device) on which a plurality of characters have been subjected to the single-point manipulation and a game device 100 (manipulated game device) on which its manipulated character has been subjected to the single-point manipulation on the manipulating game device. Single-point manipulation post-processing is executed when a time to generate a single-point manipulation post-processing event, which is determined during execution of single-point manipulation processing, has been reached.

Single-point manipulation post-processing performed on the manipulated game device 100 includes rendering processing to move the external character as in S405 executed in single-point manipulation processing, processing to obtain a parameter increasing or decreasing item as in S406, and rendering processing to move the external character as in S410. Single-point manipulation post-processing performed on the manipulating game device 100 includes rendering processing to move the manipulated character to the manipulated game device 100, notification processing to indicate that the manipulated character is moving as in S413 executed in single-point manipulation processing, and rendering processing to return the manipulated character as in S417.

Information about a date and time to generate an event after the completion of single-point manipulation may be determined on either game device 100 when, for example, necessary information is exchanged in single-point manipulation processing and may be transferred. As illustrated in, for example, FIG. 8C, information about the determined date and time to generate an event is managed in both game devices 100 as a post-single-point-manipulation event generation data and time 824 together with the communication count 822 and closeness 823, in relation to the device ID 821 of the distant game device 100.

Communication Game Processing

The game device 100 in this embodiment not only can perform single-point manipulation processing but also can execute a communication game through communication with another game device 100.

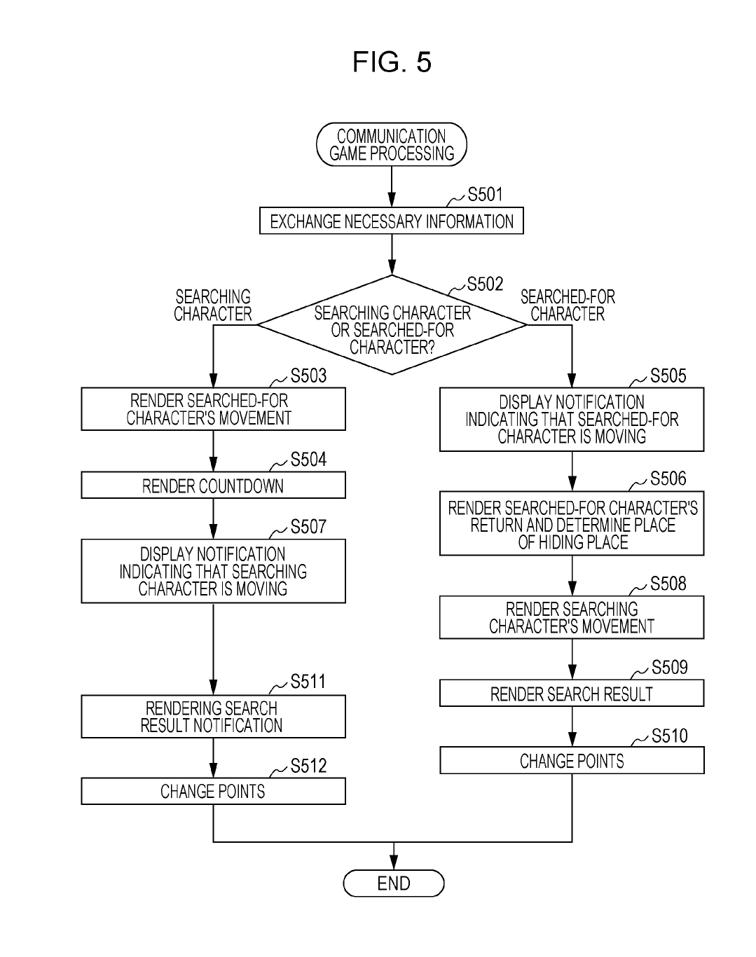

Communication game processing executable with a plurality of game devices 100 mutually connected for communication will be specifically described with reference to the flowchart in FIG. 5. Processing in the flowchart is executed by each CPU 101 in the plurality game devices 100 mutually connected for communication. In this communication game processing, a so-called hide-and-seek game, which is an example of communication games, will be described in which a manipulated character (searching character or host character) on one game device 100 moves to another game device 100 and searches for a manipulated character (searched-for character or guest character) on the other game device 100. In the description below, this communication game processing is assumed to be executed when, for example, a plurality of game devices 100 set in a communication mode to execute a communication game are mutually connected for communication. To simplify the description below, processing is assumed to be carried out between two game devices 100. However, this is not a limitation; this processing can be executed among more than two game devices 100.

In S501, the CPU 101 exchanges necessary information with the distant game device 100.

In S502, the CPU 101 determines whether the manipulated character to be brought up on the local game device 100 becomes a searching character or a searched-for character. Whether the manipulated character becomes a searching character or a searched-for character may be determined according to whether, for example, a prescribed manipulation input is first made on a game device 100 on which the character is to be brought up after a communication connection has been established, as in single-point manipulation processing. Alternatively, this determination may be made according to whether, for example, a game device 100 on which the character is to be brought up has been set in a communication mode to execute a communication game as the host device. If the CPU 101 determines that the manipulated character becomes a searching character, processing proceeds to S503. If the CPU 101 determines that the manipulated character becomes a searched-for character, processing proceeds to S505.

In S503, the CPU 101 displays the rendering of searched-for character's movement from the distant game device 100 (searched-for device). In S504, the CPU 101 displays the rendering of a countdown performed when the searched-for character hides after the searched-for character has returned to the distant game device 100.

If the CPU 101 determines that the manipulated character becomes a searched-for character, in S505 the CPU 101 displays a notification indicating that the searched-for character is moving toward the distant game device 100 (searching device). In S506, after the searched-for character has returned to the local game device 100, the CPU 101 accepts a manipulation input that determines a period corresponding to a countdown on the searching device and a hiding place of the searched-for character.

If the local game device 100 is a searching device, when the countdown started in S504 reaches 0, in S507 the CPU 101 displays a notification indicating that the searching character is moving toward the searched-for device. After a prescribed time has elapsed, processing proceeds to S511. The prescribed time taken until the processing has proceeded to S511 is a time taken by the searching character to search for the searched-for character on the searched-for device, which is the distant party, and to display rendering involved in a notification of a search result.

If the local game device 100 is a searched-for device, in S508 the CPU 101 displays the rendering of searching character's movement toward the local game device 100. In S509, the CPU 101 displays the rendering of searching character's search for the searched-for character and the rendering of a notification of a search result. With the game content in this embodiment, a game result in a communication game is determined by a parameter of the manipulated character being brought up on each game device 100 participating in the communication game. For example, the search result in S509 is determined according to the parameter 816 in the necessary information obtained as a result of the exchange in S501 and the parameter 806 of the manipulated character (searched-for character) on the game device 100 (searched-for device) on which to display the search result.

In S510, the CPU 101 changes the own points 809 according to the search result, and then completes this communication game processing. Specifically, if the search result indicates that the searching character could not search for the searched-for character (the searched-for character wined), the CPU 101 increases the own points 809 in the game information by prescribed points; if the search result indicates that the searching character could search for the searched-for character (the searched-for character lost), the CPU 101 may increase the own points 809 by points that are less than in a win as a reward for the participation to the communication game, may not change the points, or may decrease the points, according to a game rule.

The method of determining a game result is not limited to a method in which a win or a loss is determined for each character through the above parameter comparison. For a game in which a plurality of characters work in cooperation or a similar game, the game result may be determined from win/loss information about the game or other information according to, for example, the sum of parameters of all characters. In the case of a success in the game, the own points 809 of each game device 100 that has participated in the communication game are increased.

If the local game device 100 is a searching device, in S511 the CPU 101 displays the rendering of searching character's return to the local game device 100 and the rendering of a notification of a search result. A search result is determined on the searching device by referring a parameter on the local game device 100 as in the case in which the local game device 100 is a searched-for device. In S512, the CPU 101 changes the own points 809 according to the search result, and then completes this communication game processing. Specifically, if the search result indicates that the searching character could not search for the searched-for character, the CPU 101 increases the own points 809 in the game information by prescribed points, as in S510.

In this communication game processing, two types of processing, either of which is carried out depending on whether one game device 100 becomes a searching game device or searched-for game device, are has been described according to the flowchart in FIG. 5. If, for example, the two types of processing are carried out on two game devices 100, however, times to execute steps in the processing are predetermined as described below. S503 on the searching device and S505 on the searched-for device are executed at the same time, and S504 on the searching device and S506 on the searched-for device are executed at the same time. After processing in S507 has been started on the searching device, processing in S508 and S509 are executed on the searched-for device, after which processing in S511 is executed on the searching device. Thus, the progress of the communication game (hide-and-seek game), which is executed between two game devices 100 while characters are moving therebetween, can be preferably rendered.

Although, in this embodiment, the own points 809 have been changed according to the search result (game result), this is not a limitation; the value of the parameter 806 of the manipulated character may be increased or decreased similarly according to the search result.

Use of the Accessory

Next, the use of the accessory 200, which is removably attached to the game device 100 in this embodiment, will be described below. Additional elements to the game content and other data are stored in the recording unit 201 in the accessory 200 in this element, as described above. Specifically, as illustrated in FIG. 8D, the data stored in the recording unit 201 includes an accessory ID 831, which identifies the accessory 200, an accessory type 832, which identifies the type of the accessory 200, additional data 833, which is additional elements to the game content, and a linked device ID 834, which indentifies a game device 100 to which the accessory 200 is linked.

For game content executed on the game device 100, the accessory 200 in this embodiment holds data involved in at least either of items and characters as the additional data 833. Item data used as additional data includes, for example, food to be given to the manipulated character and decorations that add graphics to the manipulated character. Character data used as additional data is, for example, data, about characters having types and forms, which has not been originally present in the ROM 102 in the game device 100. These types of additional data to be stored in the recording unit 201 can be retrieved in the game device 100 by setting a link of the accessory 200 to the game device 100, after which game content in which the additional data is used can be executed. If, for example, the accessory 200 having item data is linked to the game device 100, the user can use the item data in the game to, for example, add decorations to the manipulated character. Alternatively, if, for example, the accessory 200 having character data is linked to the game device 100, the user can bring up a character involved in the character data as the manipulated character in the game.

The state in which the game device 100 and accessory 200 are mutually linked refers to a state in which the additional data 833 in the accessory 200 has been stored in the RAM 103 in the game device 100, as described above. Whether the state is a linked state is determined depending on whether information that identifies the distant linked device or its accessory 200 has been stored as the linked accessory information 808 in the game information stored in the RAM 103 and also as the linked device ID 834 stored in the recording unit 201. Alternatively, on the game device 100, whether the state is a linked state may be determined simply depending on whether information is stored in the game information as the linked accessory information 808.

Link Processing

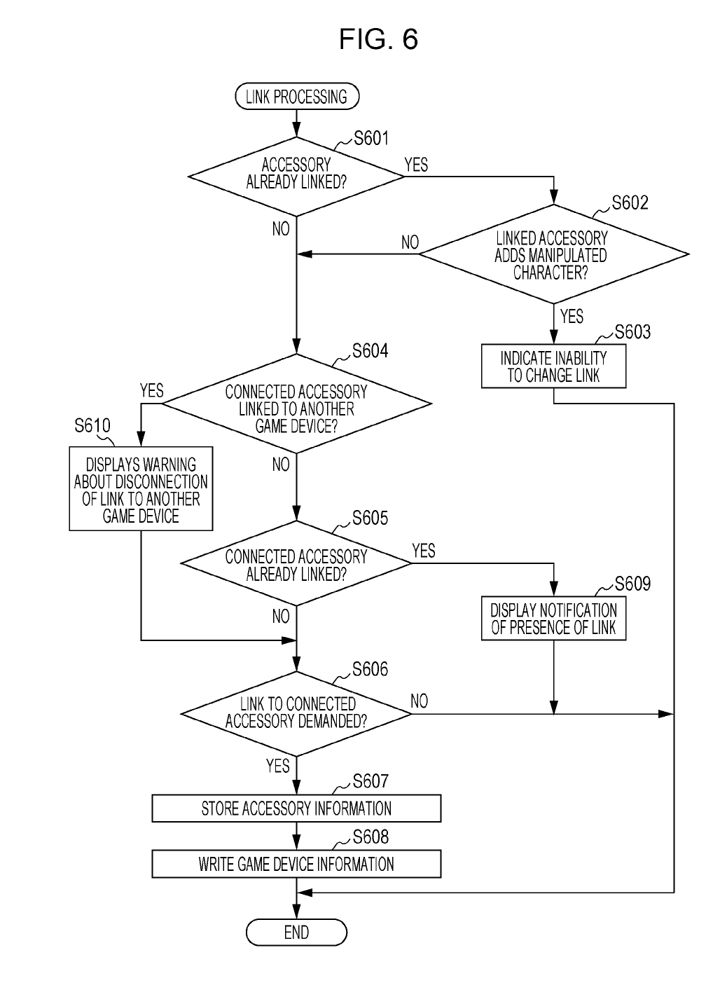

Link processing is performed to link, to the game device 100, the accessory 200 attached to the game device 100. Now, link processing will be described in detail with reference to the flowchart in FIG. 6. In the description below, this link processing is assumed to be started when a menu, provided in the game, to link the accessory 200 is selected with the accessory 200 attached to the game device 100.

In S601, the CPU 101 determines whether the game device 100 includes a linked accessory 200, which is an accessory 200 already linked to the game device 100. Specifically, the CPU 101 references the linked accessory information 808 in the game information stored in the RAM 103 and determines whether an accessory ID that identifies a linked accessory 200 is included in the linked accessory information 808. If the CPU 101 determines that there is a linked accessory 200, processing proceeds to S602. If not, processing proceeds to S604.

In S602, the CPU 101 determines whether the linked accessory 200 retains a manipulated character currently being brought up on the game device 100 as additional data. Specifically, the CPU 101 references the linked accessory information 808 in the game information and determines whether the accessory type of the linked accessory 200 is intended to add character data. If the CPU 101 determines that the linked accessory 200 retains a manipulated character as additional data, processing proceeds to S603. If not, processing proceeds to S604. When the game device 100 and accessory 200 are mutually linked, the accessory ID 831, accessory type 832, and additional data 833, which are part of data stored in the recording unit 201, are stored in the RAM 103 as the linked accessory information 808 in the game information, as described later in detail.

In S603, the CPU 101 displays, on the display unit 105, a notification indicating that the link of the linked accessory 200 cannot be changed because the manipulated character, which is additional data to the liked accessory, is currently brought up. Then, the CPU 101 completes this link processing.

In S604, the CPU 101 determines whether the attached accessory 200 (connected accessory) is linked to another game device 100. Specifically, the CPU 101 references the linked device ID 834 stored in the recording unit 201 of the connected accessory 200 through the recording control unit 109 and determines whether a device ID other than the device ID 801 of the local game device 100 is stored. If the CPU 101 determines that the connected accessory 200 is linked to another game device 100, processing proceeds to S610. In S610, the CPU 101 displays, on the display unit 105, a warning indicating that the link to the other game device 100 will be disconnected, after which processing proceeds to S606. If the CPU 101 determines that the connected accessory 200 is not linked to another game device 100, processing proceeds to S605.

In S605, the CPU 101 determines whether the connected accessory 200 is already linked to the game device 100. Specifically, the CPU 101 determines whether there is a match between the accessory ID 831 stored in the recording unit 201 in the connected accessory 200 and the accessory ID included in the linked accessory information 808 in the game information. If the CPU 101 determines that the connected accessory 200 is already linked, processing proceeds to S609. In S609, the CPU 101 displays, on the display unit 105, a notification indicating that the connected accessory 200 is already linked, and then completes this link processing. If the CPU 101 determines that the connected accessory 200 is not yet linked, processing proceeds to S606.

In S606, the CPU 101 displays, on the display unit 105, a notification asking whether to link to the connected accessory 200 and waits for the user to make a manipulation input about whether to create a link. If the CPU 101 determines, from the user's manipulation input, that a link to the connected accessory 200 is to be created, processing proceeds to S607. If not, the CPU 101 completes this link processing.

In S607, the CPU 101 reads out the accessory ID 831, accessory type 832, and additional data 833 from the recording unit 201 in the connected accessory 200, and stores them in the RAM 103 as the linked accessory information 808. In S608, the CPU 101 reads out the device ID 801 in the game information from the RAM 103, transfers the device ID 801 to the recording control unit 109, and causes the recording unit 201 to record the device ID 801 as the linked device ID 834. Then, the CPU 101 completes this link processing. When processing in S607 and S608 is executed in this way, a link between the game device 100 and the attached accessory 200 can be set.

Delinking Processing

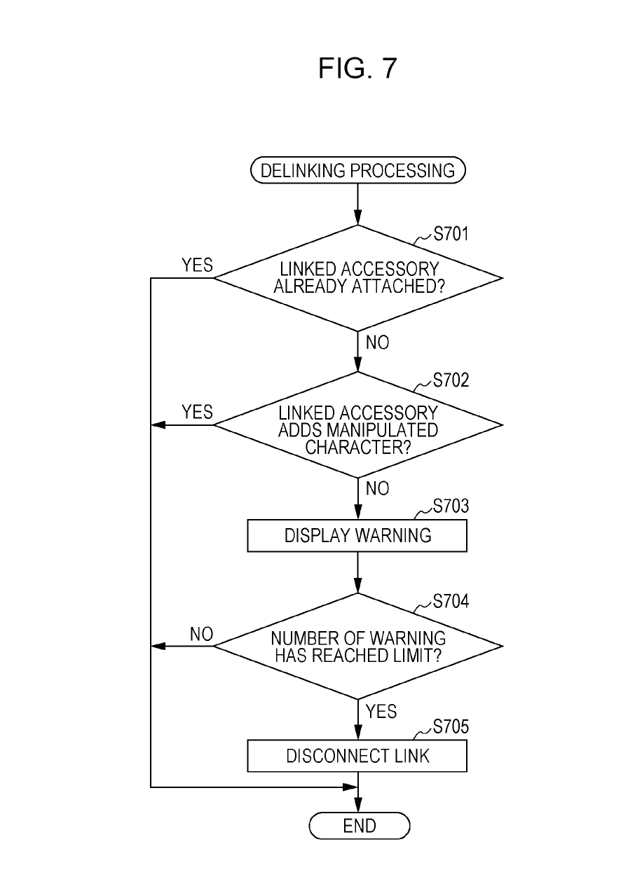

Next, delinking processing will be described in detail in which if the accessory 200 linked to the game device 100 is not attached to the game device 100 for a prescribed time, the link is automatically disconnected, with reference to the flowchart in FIG. 7. In the description below, this delinking processing is assumed to be periodically executed during execution of game content. At night in which the manipulated character enters a sleep mode, this delinking processing may not be executed because notifications are less likely to be recognized by the user.

In S701, the CPU 101 determines whether the linked accessory 200 has been attached to the game device 100. Whether the linked accessory 200 has been attached to the game device 100 is determined according to, for example, the attachment state of the accessory 200, the attachment state being detected by the recording control unit 109, or where the accessory ID 831 to be stored in the recording unit 201 matches the accessory ID included in the linked accessory information 808 included in the game information. If the CPU 101 determines that the linked accessory 200 has been attached, the CPU 101 completes this delinking processing. If not, processing proceeds to S702.

In S702, the CPU 101 determines whether the linked accessory 200 retains a manipulated character currently being brought up on the game device 100 as additional data. If the CPU 101 determines that the linked accessory 200 retains a manipulated character as additional data, the CPU 101 completes this delinking processing. If not, processing proceeds to S703. This is because if a link to an accessory 200 that retains a manipulated character as additional data is disconnected, a link to another accessory 200 becomes possible, so graphic data of the manipulated character being brought up and other data may be lost by being overwritten. That is, in S702, if the accessory type of the linked accessory 200 indicates that character data is added, the CPU 101 does not disconnect the link of the linked accessory 200.

In S703, the CPU 101 displays, on the display unit 105, a warning that prompts the user to attach the linked accessory 200 to the game device 100 to avoid its link from being disconnected.

In S704, the CPU 101 determines whether the number of warnings in S703 has reached a maximum allowable number of warnings. In the game content in this embodiment, if a linked accessory 200 is not attached to the game device 100 within a prescribed number of warnings, its link is automatically disconnected. Information about the number of warnings is stored in the RAM 103 by the CPU 101 each time S703 is executed, for example. The warning displayed when the number of warning has reached the maximum allowable number of warnings may be a notification indicating that the link will be disconnected. If the CPU 101 determines that the number of warning has reached the maximum allowable number of warnings, processing proceeds to S705. If not, the CPU 101 completes this delinking processing.

In S705, the CPU 101 deletes data involved in the linked accessory information 808 from the linked accessory information 808 in the game information stored in the RAM 103, and then completes this delinking processing.

As described above, the game device 100 in this embodiment can reduce restrictions on the behavior of a user who uses the game device 100. Specifically, the game device 100 executes a game in which a manipulated character is brought up. Upon accept of a first manipulation input, the game device 100 controls events generated for the manipulated character in the game so that they are placed in the non-generation state, in which generation of events that requires a manipulation input by the user is disabled.

Thus, even in a situation in which the user cannot carry the game device 100, generation of events disadvantageous to the user can be disabled.

What is claimed is:

1. A game device that executes a bringing-up game in which a manipulated character is brought up, the device comprising:
an event generating means that generates an event concerning the manipulated character;
an input means that accepts a manipulation input by a user; and
a control means that controls generation of an event by the event generating means, the event requiring a manipulation input by the user; wherein
when the input means accepts a first manipulation input, the control means controls the event generating means so as to be placed in a non-generation state in which the event generating means is not allowed to generate the event that requires a manipulation input.

2. The game device according to claim 1, further comprising a point managing means that manages points associated with the user in the bringing-up game, wherein
the manipulated character has at least two growth stages, and
when the first manipulation input is accepted in at least one stage of the at least two growth stages of the manipulated character, the control means controls the event generating means so as to be placed in the non-generation state under a condition that a prescribed number of points are subtracted from the points associated with the user.

3. The game device according to claim 2, wherein when the first manipulation input is accepted in a stage other than the at least one stage of the manipulated character, the control means controls the event generating means so as to be placed in the non-generation state without the condition that a prescribed number of points are subtracted from the points associated with the user.

4. The game device according to claim 3, further comprising an obtaining means that obtains a current time, wherein
when the current time obtained by the obtaining means reaches a prescribed time, when the points associated with the user falls to or below a prescribed number of points, or when the input means accepts a manipulation input that requires a shift to a generation state, in which the event that requires a manipulation input is allowed to be generated, the control means controls the event generating means so that the non-generation state is shifted to the generation state.

5. The game device according to claim 4, wherein:
when the current time reaches a first time in the at least one stage, the control means controls the event generating means so that the non-generation state is shifted to the generation state; and
when the current time reaches a second time, which is later than the first time, in a stage other than the at least one stage, the control means controls the event generating means so that the non-generation state is shifted to the generation state.

6. The game device according to claim 1, further comprising a notification means that indicates generation of the event that requires a manipulation input through at least one of a display given on a display means and a sound reproduced by a sound reproducing means, wherein
the event generating means generates the event that requires a manipulation input at least once in a day.

7. The game device according to claim 1, further comprising a rendering means that performs a rendering operation about the manipulated character through at least one of the display given on the display means and the sound reproduced by the sound reproducing means, wherein
the first manipulation input is a manipulation input to entrust the manipulated character to a facility,
when the event generating means is shifted from the generation state, in which the event that requires a manipulation input is allowed to be generated, to the non-generation state, the rendering means performs a rendering operation by which the manipulated character moves to the facility, and
when the event generating means is shifted from the non-generation state to the generation state, the rendering means performs a rendering operation by which the manipulated character returns from the facility.

8. The game device according to claim 1, further comprising:
a display control means that displays graphic data including the manipulated character on the display means; and
a communication means that communicates with at least one other game device; wherein
when the communication means communicates with the other game device,
the display control means displays, on the display means, not only a host character, which is a manipulated character on the local game device but also a guest character, which is a manipulated character on the other game device, together with graphic data used during communication, and
the event generating means generates a communication-time event through which the host character and guest character are manipulated.

9. The game device according to claim 8, wherein:
during communication among a plurality of game devices through the communication means, a game device that first receives a second manipulation input among the plurality of game devices becomes a host game device that brings up the host character and each game device other than the host game device becomes a guest game device that brings up the guest character;
the display control means of the host game device displays the host character and the guest character on the display means of the host game device; and
the display control means of the guest game device display, on the display means of the guest game device, a display indicating that the guest character is moving toward the host game device and does not display the guest character on the display means of the guest game device.

10. The game device according to claim 9, wherein:
the event generating means generates a pseudo communication event after a prescribed time has elapsed from when communication had started between the host game device and the guest game device, regardless of whether communication is in progress; and
if the pseudo communication event is generated, the display control means of the guest game device displays, on the display means of the guest game device, not only the guest character but also the host character together with the graphic data used during communication.

11. The game device according to claim 8, further comprising a parameter managing means that manages a parameter of the manipulated character, the parameter being associated with identification information about the manipulated character, the parameter including a closeness with the manipulated character on a distant game device, which is a distant party with which communication is performed, a value of the parameter being changed according to a number of communications with the distant game device, wherein
when the display control means displays the host character and the guest character on the display means, the display control means displays, on the display means, an item that changes a value of a parameter of the manipulated character on a local game device, the manipulated character being one of the host character and the guest character, the item being determined according to a closeness between the host character and the guest character, and
the parameter managing means changes the value of the parameter of the manipulated character on the local game device according to a value predetermined for the item that changes the value of the parameter of the manipulated character on the local game device.

12. The game device according to claim 8, further comprising a parameter managing means that manages a parameter of the manipulated character, the parameters being associated with identification information about the manipulated character, wherein
the parameter managing means increases a value of a parameter of the guest character after a prescribed time has elapsed from when the communication had started.

13. The game device according to claim 1, further comprising:
a point managing means that manages points associated with the user in the bringing-up game;
a display control means that displays graphic data including the manipulated character on the display means;
a communication means that communicates with at least one other game device; and
a determining means that determines a result for an event generated by the event generating means; wherein
during communication among a plurality of game devices through the communication means, the event generating means generates a communication-time event through which a host character searches for a guest character, the host character being the manipulated character on a searching game device, which is one of the plurality of game devices, the guest character being the manipulated character on a searched-for game device, which is one of the plurality of game devices other than the searching game device,
when the event generating means generates the communication-time event on the searching game device,
the display control means displays the host character and the guest character on the display means, after which the display control means displays, on the display means, rendering data indicating that the host character is moving toward the searched-for game device and rendering data indicating that the guest character is returning to the searched-for game device and also displays a result of the communication-time event, which is determined by the determining means, on the display means, after a time required to complete displaying of rendering data involved in the result of the communication-time event has elapsed, and
if the result of the communication-time event indicates that the host character has successfully searched for the guest character, the point managing means increases points managed on the searching game device, and
when the event generating means generates the communication-time event on the searched-for game device,
the display control means displays, on the display means, rendering data that indicating that the guest character is moving toward the searching game device, rendering data indicating that the guest character is returning to the searched-for game device and hides, rendering data indicating that the host character is moving toward the searched-for game device, and rendering data involved in a result of the communication-time event in succession, and
if the result of the communication-time event indicates that the host character has unsuccessfully searched for the guest character, the point managing means increases points managed on the searched-for game device.

14. The game device according to claim 8, further comprising:
a parameter managing means that manages a parameter of the manipulated character, the parameter being associated with identification information about the manipulated character; and
a determining means that determines a result for an event generated by the event generating means; wherein
the determining means determines a result of the communication-time event according to at least a parameter of the host character and a parameter of the guest character, and
the parameter managing means increases a value of the parameter of the host character or the guest character, whichever wins or succeeds, if the result of the parameter managing means, which is determined by the determining means, indicates a win or a success, and decreases the value of the parameter of the host character or the guest character, whichever loses or fails, if the result of the parameter managing means indicates a loss or a failure.

15. The game device according to claim 8, further comprising a changing means that changes the growth stage of the manipulated character, the growth stage being associated with identification information about the manipulated character, wherein while processing involved in operations of the host character and the guest character is being executed on a single game device, the changing means does not change the growth stage of at least one of the host character and the guest character.

16. The game device according to claim 1, wherein:
an accessory that has a recording means is operable to be attached to the game device;
at least accessory identification information that identifies the accessory is recorded in the recording means;
the game device further has an associating means that makes an association with the attached accessory; and
the associating means stores, in a storage means, accessory identification information stored in the recording means of the attached accessory and also records device, in the recording means, identification information that identifies the game device to associate the game device with the attached accessory.

17. The game device according to claim 16, wherein if device identification information different from device identification information about the local game device is stored in the recording means of the attached accessory, the associating means displays, on the display means, a notification indicating that an association with the game device corresponding to the device identification information different from the device identification information about the local game device will be eliminated, and accepts a manipulation input that selects whether to make an association.

18. The game device according to claim 16, wherein if the accessory having an association has been detached for a prescribed time or more, the associating means eliminate the association by deleting the accessory identification information that identifies the accessory, the accessory identification information being stored in the storage means.

19. The game device according to claim 16, wherein:
data of at least one of a character and an item that are available in the bringing-up game is recorded in the recording means; and
if the manipulated character is associated with data of a character recorded in the recording means in the accessory having an association, the associating means does not eliminate the association with the accessory.

20. The game device according to claim 16, wherein:
data of at least one of a character and an item that are available in the bringing-up game is recorded in the recording means; and
if the manipulated character is associated with data of a character recorded in the recording means in the accessory having an association, the associating means does not make an association with an accessory different from the accessory having an association.

21. A method of controlling a game device that executes a game in which a manipulated character is brought up, the method comprising of:
an event generating step of causing an event generating means in the game device to generate an event concerning the manipulated character;
an input step of causing an input means in the game device to accept a manipulation input by a user; and
a control step of causing a control means in the game device to control generation of an event in the event generating step, the event requiring a manipulation input by the user; wherein
when a first manipulation input is accepted in the input process, the control means controls event generating in the event generating step so that a non-generation state is entered in which the event that requires a manipulation input is not allowed to be generated.

22. A program that causes a computer to executes the steps in the method of controlling a game device, the method being described in claim 21.
